(19) United States
(12) Patent Application Publication
(10) Pub. No.: US 2009/0289091 A1
(43) Pub. Date: Nov. 26, 2009

(54) Cargo Rack for Cycles and Scooters

(75) Inventor: Karl T. Ulrich, Narberth, PA (US)

Correspondence Address: Karl T. Ulrich, 316 N. Essex Ave., Narberth, PA, 19072, US

(73) Assignee: XOOTR LLC, Narberth, PA (US)

(21) Appl. No.: 12/469,789

(22) Filed: May 21, 2009

Related U.S. Application Data
(60) Provisional application No. 61/055,150, filed on May 22, 2008.

(51) Int. Cl. B62J 7/00

(52) U.S. Cl. 224/447

(57) ABSTRACT

A cargo rack for bicycles or scooters consisting of a cargo frame connected by a rack stem to a vertical element of the vehicle frame, often the seat post, such that the major plane of the cargo frame is largely perpendicular to the direction of motion of the vehicle and situated largely within the projection of the cross-sectional area of the vehicle and rider. The rack stem consists of a releasable attachment that allows the cargo frame to be separated from the vehicle when not needed.

### BACKGROUND

This invention relates to cargo racks for use with devices such as bicycles, motorcycles, scooters, personal electric vehicles and other personal transportation devices. Most personal transportation devices are designed to be light and efficient, and as a result do not typically incorporate into their base configuration any means for transporting cargo. Users of these devices often wish to carry groceries, briefcases, satchels, knapsacks, tote bags, and the like.

Many aftermarket accessories have been developed to allow cargo transport. The most common such accessory for the bicycle, often called a “bike rack,” attaches over the rear wheel of a bicycle with a cargo frame that is substantially horizontal. Conventional bike racks allow bags or other forms of cargo to be mounted on top of the cargo frame. Bike bags are also commonly designed to hang from the sides of bike racks, attaching to one of the side rails of the cargo frame and hanging down on either side of the rear wheel.

Current forms of cargo racks suffer from several weaknesses.
It is difficult to attach and detach the rack from the vehicle, and so the rack must usually be mounted semi-permanently.
When saddle bags, panniers, or other bike bags are hung from the side of the rack they create additional wind resistance making the vehicle less efficient.
Hanging bags from the side of conventional racks also increases the effective width of the vehicle and rider, which can potentially make the vehicle less maneuverable in traffic or crowded spaces.
Hanging a single bag from the side of conventional racks causes an imbalance in the cargo load on the vehicle, making it less stable and harder to ride.
The narrow width of the cargo frame on conventional racks makes mounting larger bags on top of the rack difficult. Most bags designed to be mounted on top of a conventional rack are narrow, and thus have very limited storage capacity.

It is the object of this invention to provide a cargo rack that is easily mounted to a wide variety of bicycles, scooters, and similar vehicles; that may be easily separated from the vehicle; that centers the weight of the cargo over the centerline of the vehicle; and that positions the cargo within the projected cross-section of the vehicle and rider in order to minimize the increase in wind resistance created by the addition of cargo.

### SUMMARY

The invention consists of a cargo frame connected by a rack stem to a vertical element of the vehicle frame, often the seat post, such that the major plane of the cargo frame is largely perpendicular to the direction of motion of the vehicle and situated largely within the projection of the cross-sectional area of the vehicle and rider. The rack stem consists of a releasable attachment that allows the cargo frame to be separated from the vehicle when not needed.

### BRIEF DESCRIPTION OF THE DRAWINGS

These and other features, aspects, and advantages of the present invention will become better understood with regard to the following description, appended claims and accompanying drawings, where:

FIG. 1 is an overall perspective view of the cargo rack.

FIG. 2 is an overall perspective view of a vehicle to which the cargo rack can attach.

FIG. 3 is an overall perspective view of the cargo rack with a bicycle cargo bag attached.

FIG. 4 is an overall perspective view of cargo rack attached to the front of a bicycle.

FIG. 5 is an overall perspective view of the cargo rack attached to the front of a scooter.

FIG. 6 is a side view of frame clamp portion of rack stem remaining when the rest of the cargo rack is removed.

### DETAILED DESCRIPTION

A preferred embodiment of the invention is shown in FIG. 1. A cargo frame 11 is attached via a pivot clamp 124 to a rack stem 12. Pivot clamp 124 allows cargo frame 11 to be positioned in a range of angles about pivot axis 13. Pivot clamp 124 thus allows cargo frame 11 to be positioned such that it or the cargo does not interfere with the vehicle or rider.

Rack stem 12 is attached via a frame clamp 123 to a vertical element of the vehicle frame 23. The vertical element 23 in FIG. 1 is a seat post of a bicycle, but other vertical elements to which frame clamp 123 can attach include handlebar risers or scooter or bicycle frame tubes. A vertical element of the vehicle frame is a structural element of the vehicle whose major axis is oriented within 30 degrees of perpendicular to the road plane.

In a preferred embodiment, as shown in FIG. 1, Cargo frame 11 comprises an attachment rail 111, an attachment feature 112, and protrusions 113. Attachment rail 111 is similar in geometry to elements of conventional bicycle racks from which saddle bags, also known as panniers, can be hung. As a result, attachment rail 111 allows conventional saddlebags and panniers to be hung from the cargo rack. Most such bags have a hook or other feature that engages with a lower feature on the rack to secure the bag. In a preferred embodiment, attachment rail 111 is less than 12 mm in thickness and attachment feature 112 is located between 150 mm and 300 mm lower than attachment rail 111 to accommodate the mounting configuration of a standard bicycle bag.

In a preferred embodiment of the invention, as shown in FIG. 1, rack stem 12 can be separated into at least two parts, with a frame clamp portion 121 remaining with the vehicle and a cargo frame portion 122 removable with cargo frame 11. In this preferred embodiment, a locking pin 125 retains the cargo frame portion 122 and frame clamp portion 121 when the invention is mounted to the vehicle.

In a preferred embodiment, frame clamp 123 allows the invention to be positioned vertically in a variety of different locations along vertical element 23, so that cargo frame 11 does not interfere with the wheels or other elements of the vehicle.

In a preferred embodiment, cargo frame 11 is comprised of at least two protrusions 113. These protrusions serve as mounting points for bags or other accessories. The protrusions also allow conventional bags, such as plastic grocery bags, to be hung from them. Furthermore, protrusions 113 serve to prevent a bag mounted on attachment rail 111 from sliding off.

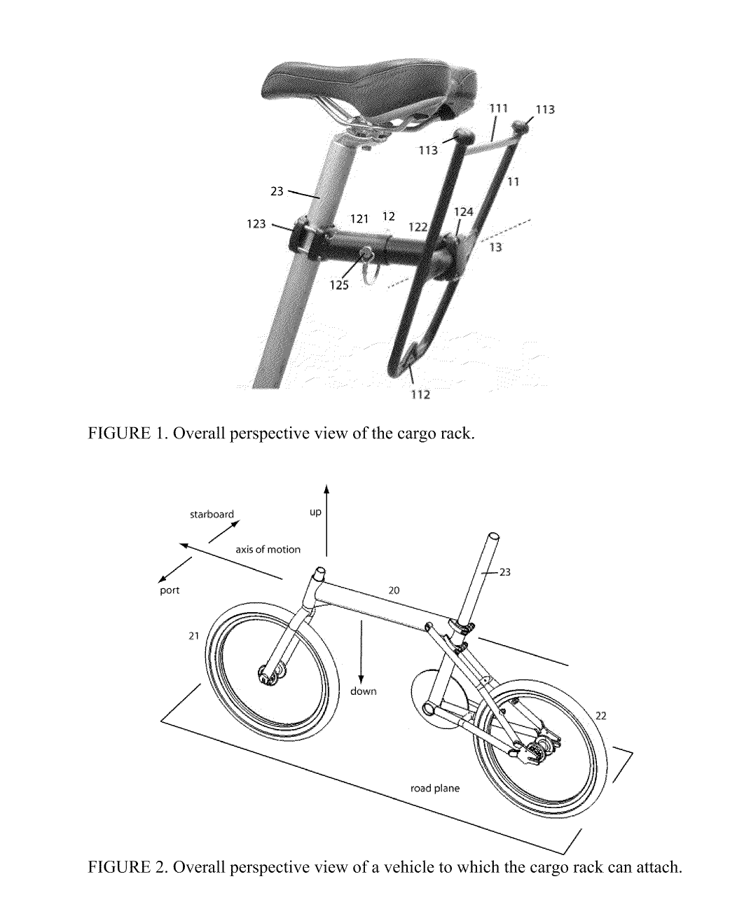

FIG. 2 is an overall perspective view of a vehicle 20 with front wheel 21, rear wheel 22, and vertical frame element 23. In a preferred embodiment, frame clamp 123 can mount to vertical element 23. In FIG. 2, frame element 23 is a seat post. However, one of the other vertical frame elements to which frame clamp 123 can mount is a riser for the handlebar system on a bicycle or scooter. FIG. 2 shows an axis of motion of the vehicle.

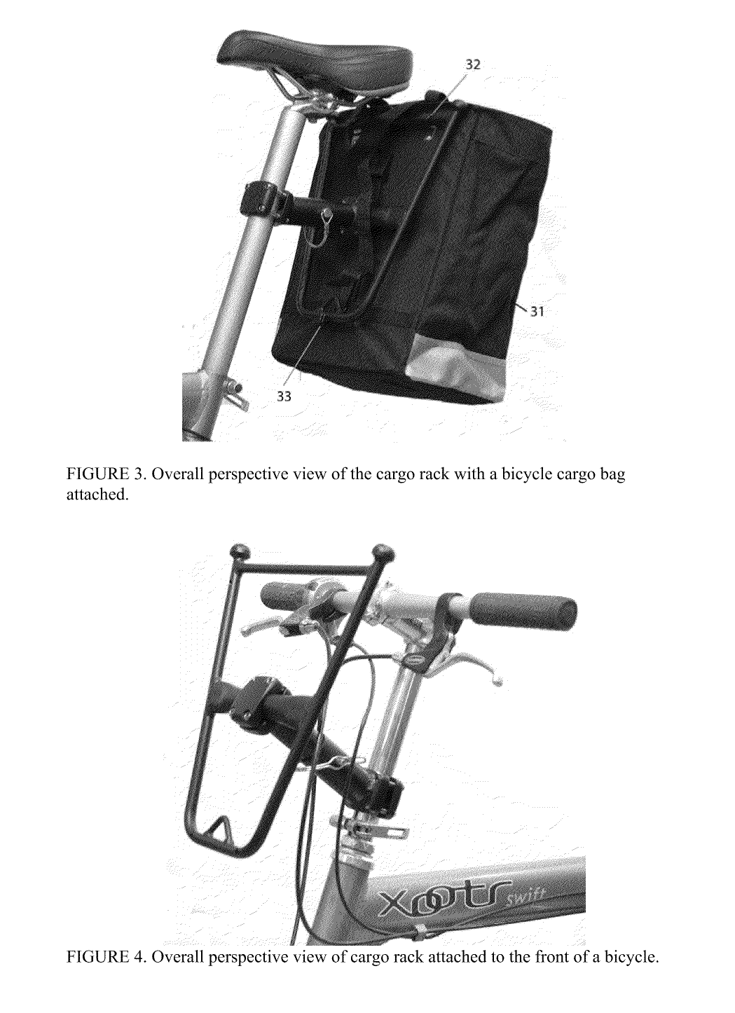

FIG. 3 is an overall perspective view showing a cargo bag 31 mounted to a preferred embodiment of the invention. A mounting hook 32 attaches to attachment rail 111. Lower hook 33 attaches to lower attachment feature 112.

FIG. 4 is an overall perspective view of a preferred embodiment of the invention attached to a vertical element, which is a riser tube for the handlebar system of a bicycle.

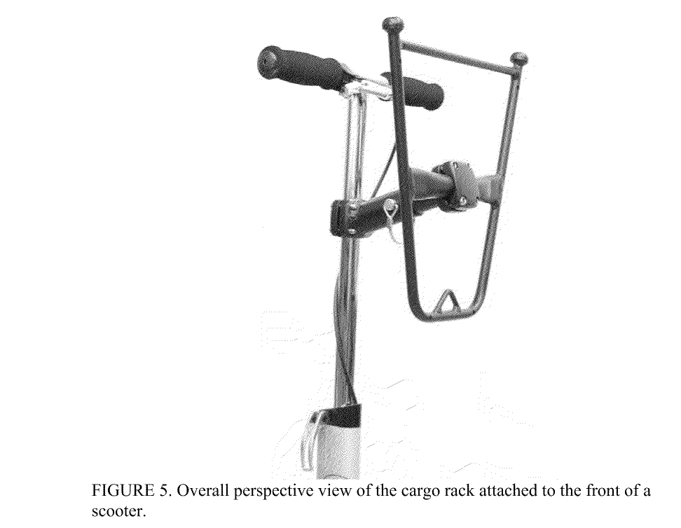

FIG. 5 is an overall perspective view of a preferred embodiment of the invention attached to a vertical element, which is a riser tube for the handlebar system of a scooter.

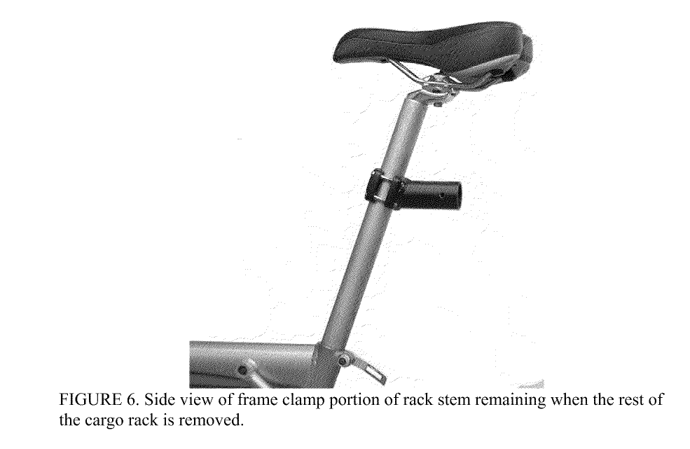

FIG. 6 is a side view of the frame clamp portion 121 of the rack stem 12. In a preferred embodiment of the invention, when locking pin 125 is removed, cargo frame 11 and the frame portion 122 of rack stem 12 may be separated from the vehicle. Other embodiments of the locking mechanism are possible, including but not limited to clips, latches, clamps, and knobs.

In a preferred embodiment of the invention, as shown in FIGS. 1, 3, 4, and 5, the cargo frame is located crosswise to the motion axis of the vehicle. The major plane of the cargo frame 11 is defined to be an imaginary flat plane located to minimize the largest distance from any point on the cargo frame to the major plane. In the preferred embodiment shown in FIG. 1, the major plane cuts through attachment rail 111 and attachment feature 112. In a preferred embodiment of the invention, the major plane of the cargo frame is oriented so that it is crosswise to the axis of motion of the vehicle. The major plane is crosswise when it is located within 30 degrees of perpendicular to the axis of motion of the vehicle. This crosswise orientation and position has many benefits. This orientation and position of the cargo frame allows cargo to be located close to the vertical element of the vehicle to which the cargo frame is attached, and it allows for the cargo load to be centered over the axis of motion of the vehicle, and it allows for the cargo to be located substantially within the projection of the cross-section of the rider and vehicle along the axis of motion of the vehicle, thus limiting any increase in wind resistance due to the cargo. In a preferred embodiment of the invention, the cargo can be located aft of the rider, as when mounted to a seat post, or forward of the rider, as when mounted to a handlebar riser.

The foregoing discussion should be understood as illustrative and should not be considered to be limiting in any sense. While this invention has been particularly shown and described with reference to preferred embodiments thereof, it will be understood by those skilled in the art that various changes in form and details may be made therein without departing from the spirit and scope of the invention as defined by the claims.

I claim:

1. A cargo rack for a vehicle comprising (a) a cargo frame and (b) frame attachment means for connecting said cargo frame to a vertical element of said vehicle, whereby the major plane of said cargo frame is substantially crosswise to the axis of motion of said vehicle.

2. The cargo rack of claim 1 further comprising a rack stem, wherein said rack stem and said cargo frame are connected by a lockable pivot, allowing the angle of said major plane with respect to said rack stem to be adjusted.

3. The cargo rack of claim 1 further comprising a vehicle frame clamp for attachment to said vertical element and releasable attachment means, wherein said cargo frame can be removed from said vehicle without requiring the removal of said frame clamp from said vehicle element.

4. The cargo rack of claim 1 wherein said cargo frame is further comprised of an upper attachment rail and a lower anchor feature, wherein said attachment rail and said anchor feature allow attachment of a bicycle bag.

5. The cargo rack of claim 1 wherein said cargo frame is further comprised of a plurality of protrusions.

6. A cargo rack for a vehicle comprising a cargo frame and a rack stem for connecting said cargo frame to a vertical element of said vehicle, whereby the major plane of said cargo frame is substantially crosswise to the axis of motion of said vehicle; and wherein said rack stem and said cargo frame are connected by a lockable pivot, allowing the angle of said major plane with respect to said rack stem to be adjusted; and wherein said rack stem is further comprised of a vehicle frame clamp, for attachment to said vertical element, and releasable attachment means, wherein said cargo frame can be removed from said vehicle without requiring the removal of said frame clamp from said vertical element.
